(19) United States
(12) Patent Application Publication
(10) Pub. No.: US 2025/0269513 A1
(43) Pub. Date: Aug. 28, 2025

(54) SYSTEM OF INDIVIDUAL TOOL HOLDERS FOR ORGANIZING THE CONTENTS OF DRAWERS

(71) Applicant: 1760631 Alberta Ltd., Nisku (CA)

(72) Inventors: Charles-Antoine Marois, Nisku (CA); Nathan Michael Ryhard, Nisku (CA)

(21) Appl. No.: 18/593,333

(22) Filed: Mar. 1, 2024

(30) Foreign Application Priority Data
Feb. 23, 2024 (CA) 3,230,064

(51) Int. Cl. B25H 3/04

(52) U.S. Cl. CPC B25H 3/04

(57) ABSTRACT

The present invention is a drawer organizing system consisting of a series of individual holders designed to hold the ends of various common tools and items, allowing a user to create a customized layout of holders within a drawer that is perfectly suited to fit the tools and items that they want to store and keep organized. Special adhesive stickers on the bottoms of the holders allow the holders to be securely fixed in place, as well as be repositioned with ease without leaving any adhesive residue.

### TECHNICAL FIELD

The invention relates to organizational products that help organize tools or other items within drawers or toolboxes.

### BACKGROUND

The following paragraphs are not an admission that anything discussed in them is prior art or part of the knowledge of persons skilled in the art.

Mechanics and handymen/handywomen often have a large number of various tools that they need to keep organized in a toolbox drawer. Staying organized is important for both professionals and hobbyists to save time and frustration as a well-organized toolbox allows one to find the tool they need quickly and easily. Many organizational systems exist, but often are fitted for a particular number of specific tools that may not exactly match with the end user's tools. Other organizers cannot be easily affixed to a toolbox drawer, causing the tools to slide around when the drawer is opened or closed. Various drawer organizer bins exist, but often of fixed sizes or layouts that cannot always accommodate the various sizes of tools and parts that need to be stored. Tools, parts, utensils, stationary, and other items are often stored in drawers in settings such as the workshop, garage, home/kitchen/bathroom, workplace/office, medical, and industrial settings; however, few drawer organizer solutions exist which can be perfectly customized to hold a wide variety of tools.

### SUMMARY

An organizational system made up of several individual holders designed to fit a variety of common tools and items that would be stored in a drawer or toolbox drawer. The holders would come with stickers to hold them in place made from a repositionable adhesive that can be removed without leaving residue or damaging the mounting surface and replaced where needed. Each holder holds only one end of each individual tool, allowing the end user to have complete control over the organization of their drawer based on the tools and other items that they need to store.

A tool organization system is disclosed comprising: a tool positioner formed of a first tool-end holder and a second tool-end holder that are structured to be spaced from one another a tool-span apart and oriented toward one another in use to cooperate to support a hand tool in a predetermined position on a hand tool storage surface; and each of the first tool-end holder and the second tool-end holder having: a base part with a storage surface connector; and a top part defining a tool receptacle.

A method is disclosed comprising connecting the first tool-end holder and the second tool-end holder of a tool organization system in spaced relationship on a storage surface; and mounting a hand tool to or on the tool positioner, with a first tool-end of the hand tool received in the first tool-end holder and a second tool-end of the hand tool received in the second tool-end holder.

In various embodiments, there may be included any one or more of the following features: Each storage surface connector comprises a pressure sensitive adhesive. Each storage surface connector comprises a reversibly reusable adhesive. The reversibly reusable adhesive comprises a polyurethane gel adhesive. The storage surface connector comprises a peel-and-stick adhesive with an adhesive layer and a removable backing layer. At least one of the tool receptacles are defined between cooperating inner guide wall surfaces of the top part. The cooperating inner guide wall surfaces comprise a pair of opposed wall surfaces that are spaced from one another and define a tool-end-receiving channel with one or more tool-receiving open lateral ends. The pair of opposed wall surfaces are connected by a bridge wall that defines a tool-enclosing closed lateral end of the tool receptacle. The cooperating inner guide wall surfaces are connected adjacent to one another. The cooperating inner guide wall surfaces are oriented transverse one another to define a closed lateral corner opposite to an open lateral tool-end-receiving corner. The cooperating inner guide wall surfaces are tapered to have decreasing distance from one another with decreasing distance from the base part. Both tool receptacles are defined by cooperating inner guide wall surfaces; and the cooperating inner guide wall surfaces of the first tool-end holder are separated to define an average separation distance that is smaller than an average separation distance defined between cooperating inner guide wall surfaces of the second tool-end holder. The cooperating inner guide wall surfaces are shaped to hold the tool-end by one or more of gravity, friction and interference fit. The cooperating inner guide wall surfaces are angled to define an oblique tool-end entry axis of the tool receptacle. The first tool-end holder comprises a ratcheting socket wrench (ratchet) drive-end tang receiver. Outer lateral sides of the first tool-end holder and the second tool-end holder are structured to nest laterally with outer lateral sides of adjacent first tool-end holders and second tool-end holders. A plurality of tool positioners. A kit comprising the plurality of tool positioners. The plurality of tool positioners are distributed about a hand tool storage surface, with the first tool-end holder and second tool-end holder of each tool positioner separated from one another and facing one another to define a tool-receiving zone therebetween. The plurality of tool positioners each support a respective unique tool between the first tool-end holder and the second tool-end holder of the respective tool positioner. The unique tools comprise hand tools, other tools, parts, or items. The unique tools comprise one or more of: a ratcheting socket wrench (rachet); a socket adapter; a screwdriver; a set of pliers; or a wrench. The hand tool storage surface is a base of a drawer in a toolbox or tool cabinet.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a top plan view of a sample layout of a tool organization system holding tools in an organized fashion, located within a drawer of a tool box, with the outline of the drawer perimeter illustrated in dashed lines.

FIG. 2 is a perspective view of a first tool-end holder and a second tool-end holder holding a ratcheting socket wrench.

FIG. 3 is a perspective view of a first tool-end holder and a second tool-end holder in an alternating layout holding screwdrivers.

FIG. 4 is a perspective view of a first tool-end holder and a pair of second tool-end holder arranged to hold a pair of pliers.

FIG. 5 is a perspective view of first tool-end holders and second tool-end holders of various sizes holding combination wrenches.

FIG. 6A is a side elevation view of a first tool-end holder and a second tool-end holder holding a ratcheting socket wrench.

FIG. 6B is an exploded view of FIG. 6A, illustrating the use of adhesive peel-and-stick pads with a ratcheting socket wrench drive end tool-end holder and a handle-end holder, for a ratcheting socket wrench.

FIG. 7A is a top plan view of the first tool-end holder of FIG. 6A.

FIG. 7B is a front-end view of the first tool-end holder of FIG. 6A.

FIG. 7C is a perspective view of the first tool-end holder of FIG. 6A.

FIG. 8A is a top plan view of the first tool-end holder of FIG. 8A.

FIG. 8B is a front-end view of the first tool-end holder of FIG. 8A.

FIG. 8C is a side elevation view of the first tool-end holder of FIG. 8A.

FIG. 8D is a perspective view of the first tool-end holder of FIG. 8A.

FIG. 9A is a top plan view of the first tool-end holder of FIG. 4.

FIG. 9B is a front-end view of the first tool-end holder of FIG. 4.

FIG. 9C is a side elevation view of the first tool-end holder of FIG. 4.

FIG. 9D is a perspective view of the first tool-end holder of FIG. 4.

FIG. 10A is a top plan view of a tool shaft holder.

FIG. 10B is a front-end view of the tool shaft holder of FIG. 10A.

FIG. 10C is a side elevation view of the tool shaft holder of FIG. 10A.

FIG. 10D is a perspective view of the tool shaft holder of FIG. 10A.

FIG. 11A is a top plan view of the first tool-end holder and the second tool-end holder of FIG. 5.

FIG. 11B is a front-end view of the first tool-end holder or the second tool-end holder of FIG. 5.

FIG. 11C is a side elevation view of the first tool-end holder or the second tool-end holder of FIG. 5.

FIG. 11D is a perspective view of the first tool-end holder and the second tool-end holder of FIG. 5.

FIG. 11E is a side elevation view of three pairs of first tool-end holders or second tool-end holders of FIG. 5 laterally nested together.

FIG. 11F is a perspective view of three pairs of first tool-end holders and second tool-end holders of FIG. 5 nested together.

FIG. 12A is a top plan view of the second tool-end holder of FIG. 4.

FIG. 12B is a front-end view of the second tool-end holder of FIG. 4.

FIG. 12C is a side elevation view of the second tool-end holder of FIG. 4.

FIG. 12D is a perspective view of the second tool-end holder of FIG. 4.

### DETAILED DESCRIPTION

Immaterial modifications may be made to the embodiments described here without departing from what is covered by the claims.

Hand tools are a diverse category of manual instruments designed to facilitate a multitude of tasks across various trades and industries. These tools are typically characterized by their non-powered nature and rely on human manipulation and force for operation. Spanners or wrenches, such as adjustable, combination and socket wrenches, are used for tightening and loosening nuts and bolts, offering versatility in fastening applications. Screwdrivers are available in various types and sizes and provide precise control for driving or removing screws. Pliers have adjustable jaws and excel in gripping, bending, and cutting tasks. Hammers serve as striking tools for driving nails or shaping materials. Saws, such as encompassing hand saws and hacksaws, enable efficient cutting of different materials. Files and rasps are used to create smooth edges or create a new shape or profile, and in some cases, they are used to remove extra material from plastic, wood, metal, or other materials. Allen keys and hex keys are simple tools that are used to drive bolts and screws with hexagonal sockets in their heads, and often have an L-shaped body with arms of unequal length. Clamps are used to hold objects together in a tight manner to prevent separation or movement via the inward application, and are generally used in repair jobs or furniture assembly. In general, hand tools encompass layout tools, such as angles, rulers, and measuring tools; striking tools such as hammers and sledges; metal cutting tools such as files, drills, and reamers; holding tools such as pliers and clamps; and sharpening and grinding tools. The aforementioned tools, typically crafted from robust materials like steel or other metal alloys, are designed to withstand the rigors of daily use. Their collective utility underscores their indispensable role in both professional and residential settings.

Tool cabinets, toolboxes, tool carts, and drawers are essential components of any well-organized workshop or garage. A tool cabinet provides a systematic and secure storage solution for an array of hand tools and related equipment. A tool cabinet is typically constructed from durable materials such as steel or high-impact plastics and is designed to withstand the demands of heavy-duty use. A tool cabinet often features multiple drawers of varying sizes, allowing for the organization of tools based on their type and size. Tool drawers are equipped with smooth-sliding mechanisms or ball-bearing slides, ensuring easy access and preventing jams. A tool cabinet may come with additional features such as lockable drawers for added security, reinforced corners for durability, and ergonomic handles for ease of transportation. A tool cabinet may contribute to the efficiency of a workspace and also help in preserving the longevity of tools by minimizing the risk of damage or loss.

The absence of tool organization within a tool cabinet may pose significant challenges in a workshop or garage environment. Without a systematic arrangement of tools, finding the required tool becomes time-consuming and may lead to frustration. A lack of organization can result in tools being jumbled together, contributing to inefficiency, as users spend valuable time searching for specific tools rather than focusing on the task at hand. Additionally, unorganized tool cabinets may lead to a cluttered workspace, hindering productivity and potentially compromising safety. The absence of designated spaces for each tool can make it difficult to track inventory and identify missing items, impacting the overall functionality of the workspace.

Various tool drawer organization systems are available to enhance the efficiency of tool cabinets, ensuring a systematic arrangement of tools and easy access in a workshop or garage setting. One commonly employed method involves the use of modular foam inserts or custom-cut foam liners that snugly fit into individual drawers, providing a designated space for each tool. This approach minimizes tool movement, reducing the risk of damage and making it visually clear if a tool is missing. Another system involves adjustable dividers within drawers, allowing users to create customized compartments for different tool types and sizes. Magnetic strips are also popular which provide a secure and space-efficient solution that can hold metal tools in place. Additionally, color-coding or labeling systems can be applied to drawers or compartments, aiding quick identification of tools and streamlining the organization process. Some advanced tool cabinets come with built-in electronic inventory systems, using radio-frequency identification (RFID) or barcode technology to track tools and alert users to missing items.

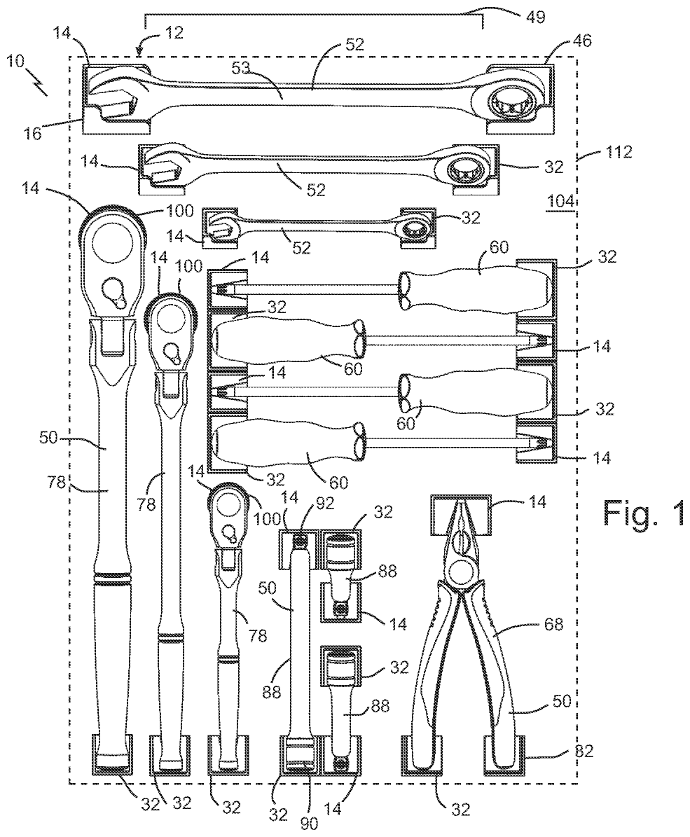

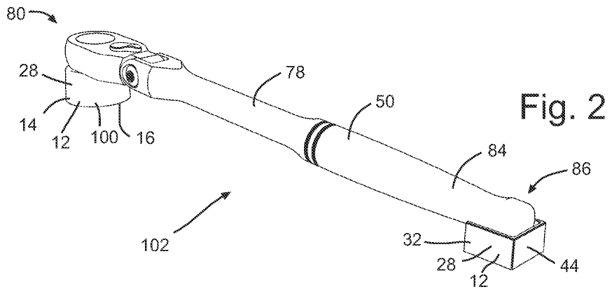

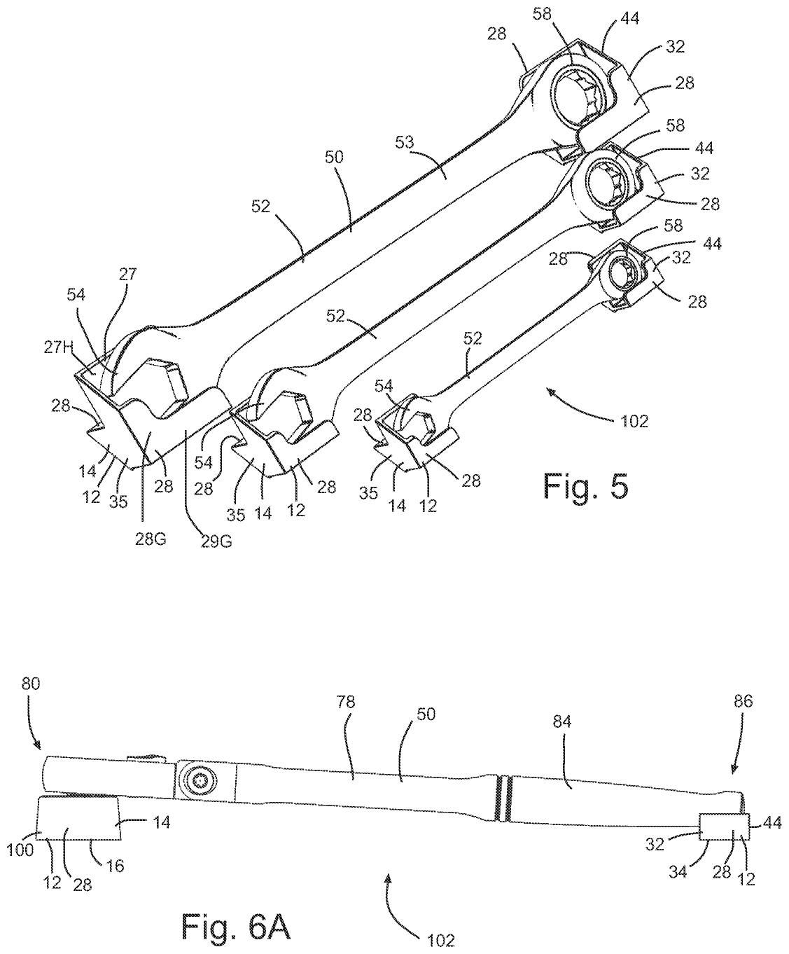

Referring to FIGS. 1-5, 6A and 6B, a tool organization system 10 is disclosed. The tool organization system 10 comprises a tool positioner 12. The tool positioner 12 may comprise a first hand-tool-end holder 14 and a second hand-tool-end holder 32. The first hand-tool-end holder 14 and the second hand-tool-end holder 32 may be structured to be spaced from one another, for example in the case of supporting a wrench 52, a hand-tool-span or distance 49 away in use (corresponding to an axial length of a hand tool 50 or part thereof) and may be oriented toward one another to cooperate to support a hand tool 50. The tool 50 may be supported in use in a predetermined position on a hand tool storage surface 104, for example located in a tool drawer 112 of a tool cabinet. The first hand-tool-end holder 14 may comprise a base part 16 and a top part 18. The base part 16 may have a storage surface connector 106. The top part 18 may define a tool receptacle 20. The system 10 may comprise of a plurality of tool positioners 12, that may be placed in, or adhered to, the inside of a drawer 112, in a user-selected arrangement of pairs or groups of tool-gripping holders to locate and secure individual tools in the drawer in an organized fashion. In addition to being used for mechanics tools in a toolbox drawer, the positioners 12 may be used to hold any number of items including, but not limited to stationery, utensils, hardware, and any other implements that can be stored in a drawer. The shapes of the positioners 12 may be designed to hold tools 50 under the hand-tool-ends to allow tools 50 to be placed into and removed from the positioners 12 by vertical movements or other movements in directions normal to the tool storage surface 104. Tools 50 may be held in place by gravity or interference fit. The positioners 12 may prevent the tools from moving laterally. An angled shape of various positioners 12 may help tools to self-center, to rest centered in the holder, contributing to the organized look and feel of the drawer. The positioners 12 may be made of plastic or other suitable material.

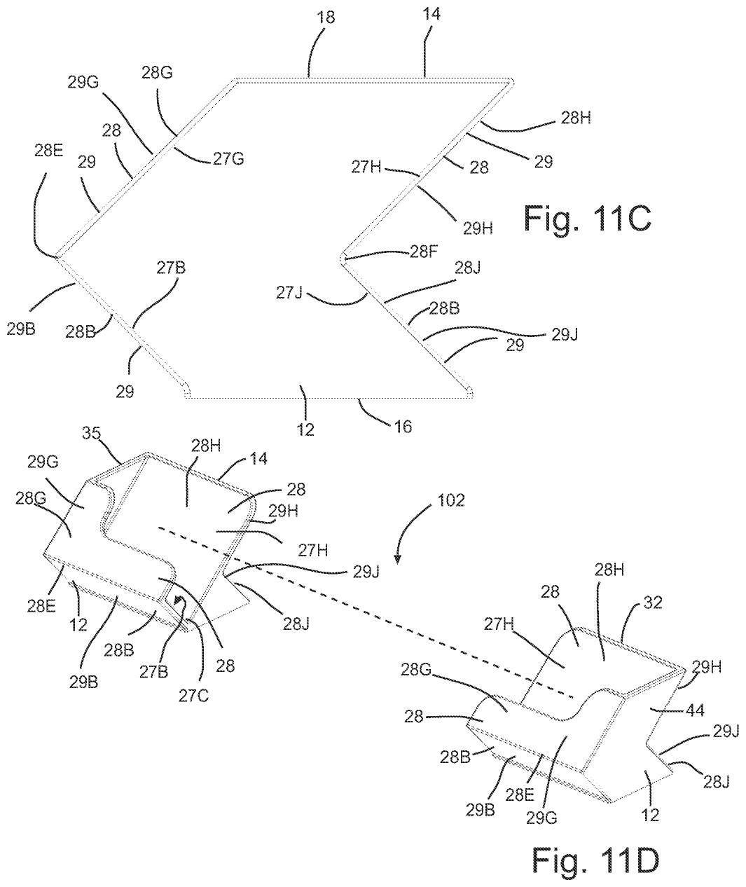

Referring to FIGS. 1-5, 6A and 6B, the first tool-end holder 14 and the second tool-end holder 32 may be configured to each hold an end of a respective hand tool 50. Each tool 50 may require two or more end holders to hold it in place, and in some cases further intermediate position holders such as a shaft holder shown in FIG. 10A, which may hold a tool at an intermediate location between the ends of the tool. Unlike other organizational systems that hold a fixed number of tools, any number of positioners 12 may be placed on the surface 104 to hold the exact number and size of the tools 50 requiring organization or for which space exists in the drawer. The plurality of tool positioners 12 may be distributed about a hand tool storage surface 104 as the user desires, with the first hand-tool-end holder 14 and second hand-tool-end holder 32 of each tool positioner 12 separated from one another and facing one another to define a tool receiving zone 102 therebetween. In a tool storage mode, a tool 50 may be mounted to each tool positioner 12 in the tool receiving zone 102, with a first hand-tool-end received in the first hand-tool-end holder 14 and a second hand-tool-end received in the second hand-tool-end holder 32.

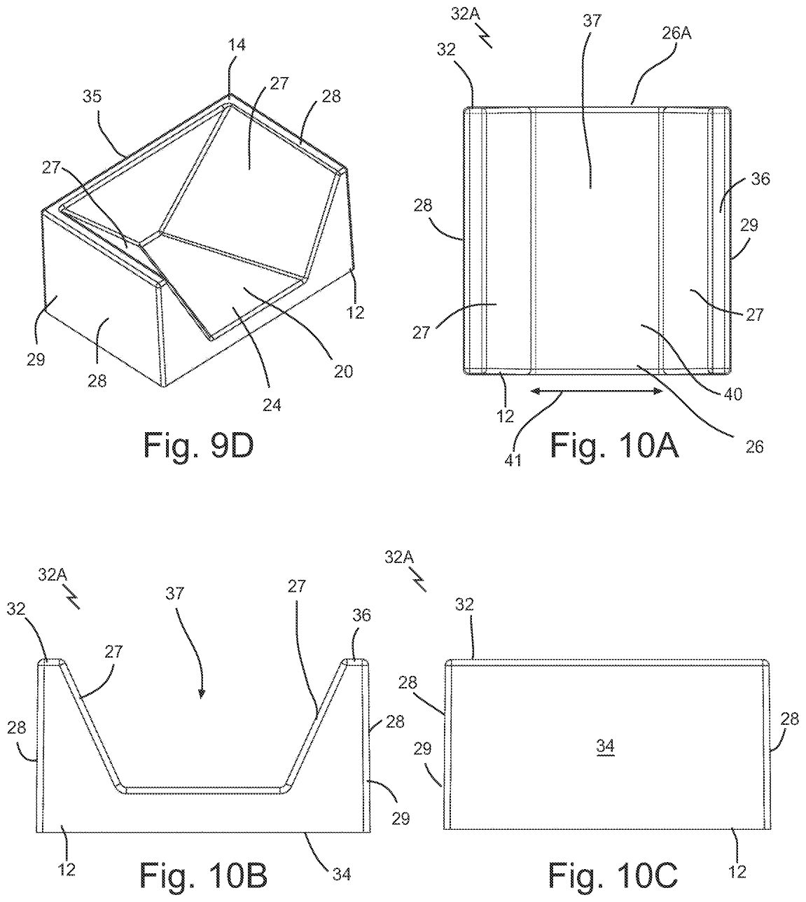

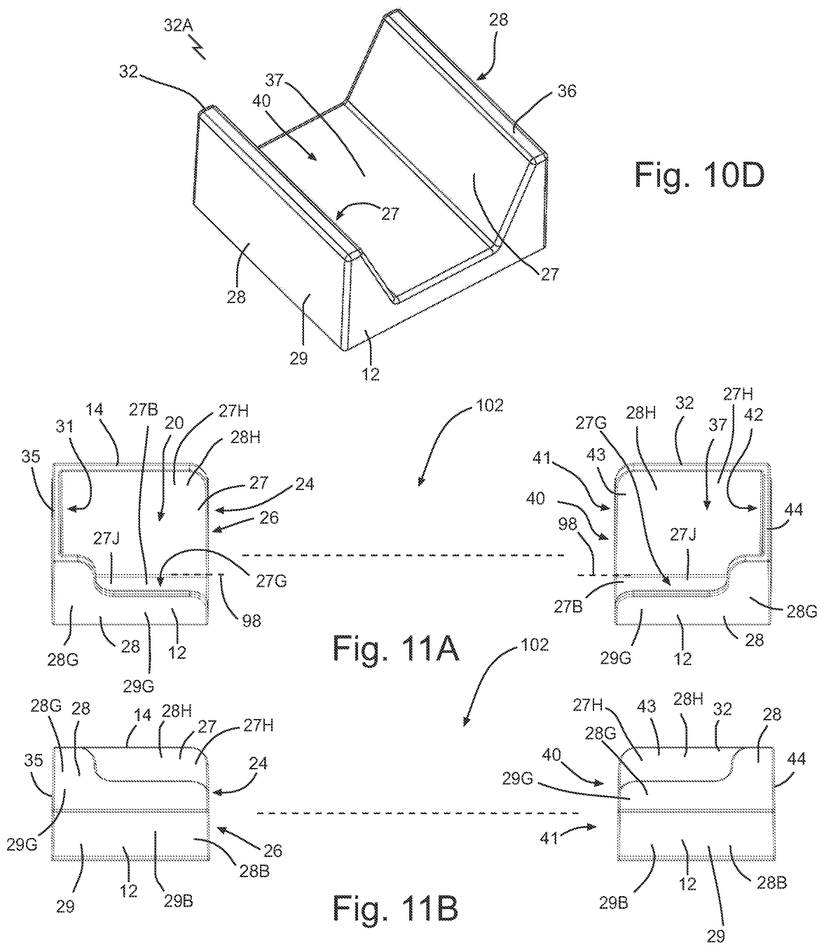

Referring to FIGS. 1-5, 6A and 6B, the plurality of tool positioners 12 may each support a respective unique tool 50 between the first hand-tool-end holder 14 and the second hand-tool-end holder 32 of the respective tool positioner 12. Referring to FIGS. 1, 5, and 11A-F, the tool positioner 12 may be used to secure a wrench 52. An open, hex-slotted end 54 of the wrench 52 may be received in the first hand-tool-end holder 14. A closed, box end 58 of the wrench 52 may be received in the second hand-tool-end holder 32. In the example shown, the box end 58 may include a ratcheting collar. A shaft 53 may extend between ends 54 and 58. Referring to FIGS. 1, 3, and 9A-D, the tool positioner 12 may be used to secure a screwdriver 60. A working end or tip 62 of the screwdriver 60 may be received in the first hand-tool-end holder 14. A handle end 66 of the screwdriver 60 may be received in the second hand-tool-end holder 32. The end holder 32 may be relatively larger than the end holder 14 to secure the relatively larger handle end 66 of the screwdriver 60. Referring to FIGS. 1, 5, and 8A-D, the tool positioner 12 may be used to secure a pair of pliers 68. A working end or tip 72 of converging jaws 70 of the pliers 68 may be received in the first hand-tool-end holder 14. An end 76 of the pair of handles 74 of the pliers 68 may be received in the second hand-tool-end holder 32. The handles 74 may each mount a respective jaw of the tip 72, which may pivot about a fulcrum 73. Referring to FIGS. 1, 2, 6A-B, and 7A-C, the tool positioner 12 may be used to secure a ratchet 78. A square drive tang 82 of the drive end 80 of the ratchet 78 may be received in the first hand-tool-end holder 14, for example, a square drive tang 82 of the ratchet 78 may be received in the receiving socket 25 of a ratchet drive gear receiver 100. An end 86 of the handle 84 of the ratchet 78 may be received in the second hand-tool-end holder 32. Referring to FIG. 1, a pair of tool positioners 12 may be used to secure a socket adapter 88. A socket end 92 of the socket extension 88 may be received in the first hand-tool-end holder 14. A ratchet end 90 of the socket extension 88 may be received in the second hand-tool-end holder 32.

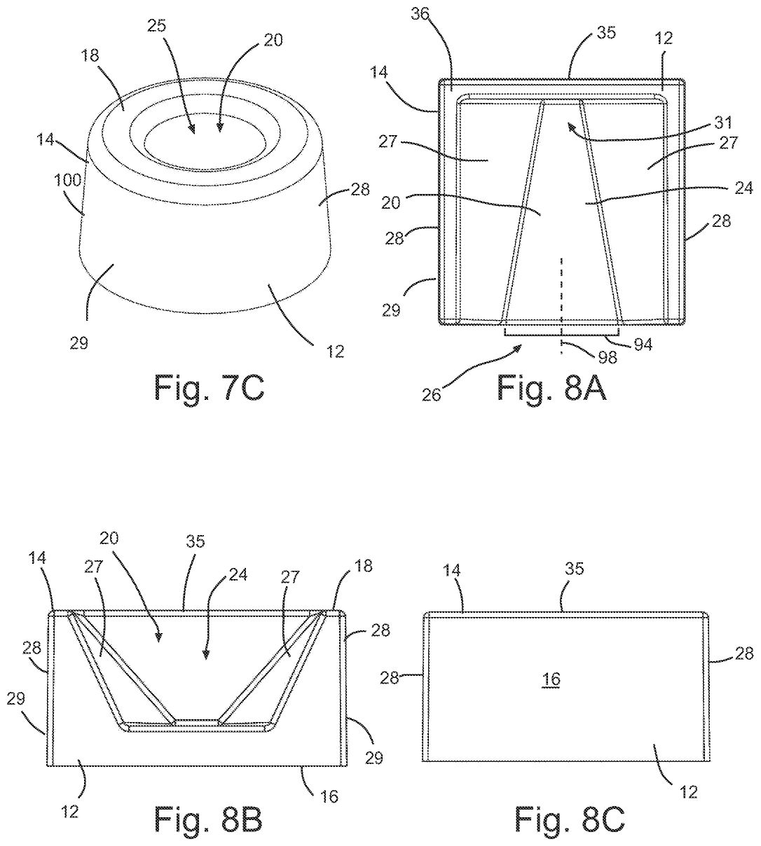

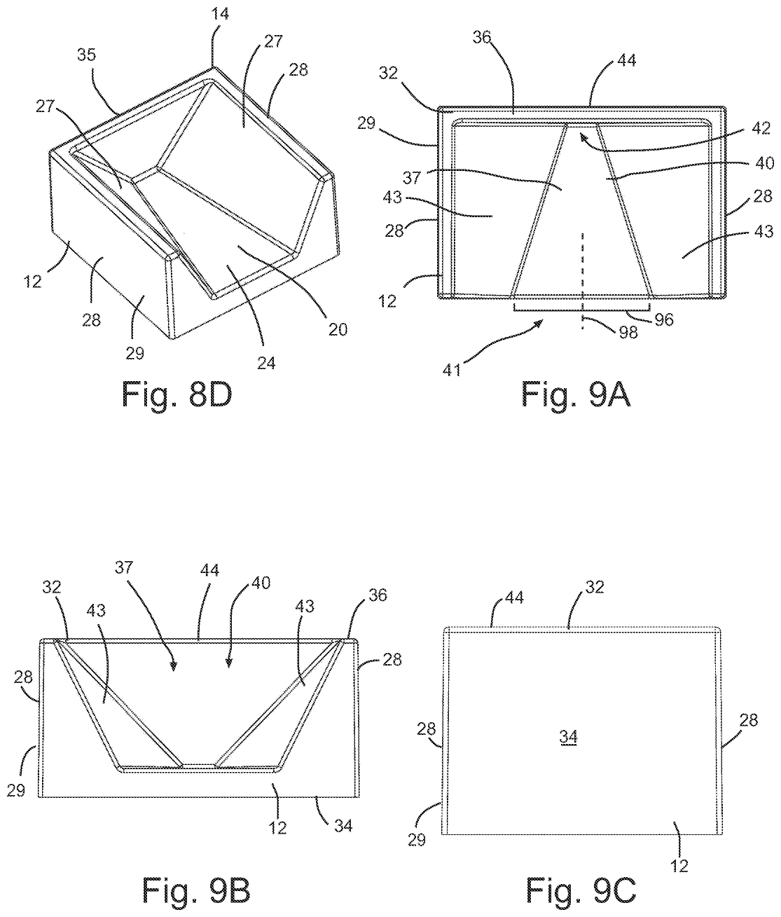

Referring to FIGS. 6A and 6B, the base parts 16 and 34 of the first tool-end holder 14 and the second tool-end holder 32, respectively, may each have a storage surface connector 106. The storage surface connector 106 may comprise an adhesive sticker or pad on the base part 16 of the first tool-end holder 14 and the base part 34 of the second tool-end holder 32. The storage surface connector 106 may permit the location of the tool holder 14 or 32 to be adjusted at the user's discretion. Unlike magnetic organization systems, the use of an adhesive storage surface connector 106 may permit the holders to be applied to a wider variety of surfaces, including non-ferrous surfaces such as wood; the adhesive storage surface connector 106 may provide stronger adhesion than a magnet to prevent undesired movement of the tool positioners 12. The storage surface connector 106 may be applied overtop of a drawer liner in some cases.

Referring to FIGS. 6A and 6B, each storage surface connector 106 may comprise a pressure sensitive adhesive. Pressure-sensitive adhesives (PSAs) represent a class of adhesives that adhere to surfaces through the application of pressure normal to the substrate. PSAs may exhibit a unique property of forming an instant bond when subjected to light pressure. The tackiness of PSAs may allow for easy application and repositioning. The adhesive strength of the PSAs may be a function of the contact time and pressure applied during application. PSAs may be formulated to exhibit specific characteristics, such as low or high tack, removable or permanent bonds, and resistance to environmental factors. PSAs ability to adhere to a wide range of substrates, coupled with their convenience and adaptability, makes pressure-sensitive adhesives a popular choice for many industrial and consumer applications.

Referring to FIGS. 6A and 6B, each storage surface connector 106 may comprise a reversibly reusable adhesive. The use of a repositionable adhesive may allow the user to secure the positioners 12 to the surface 104 in any positions without limitation. The use of an adhesive means no special substrate or purpose-built mounting base part needs to be installed on the surface 104 in order to position and affix the holders to the substrate, saving vertical space, installation hassle, and cost. The connector 106 may be a suitable connector that is intended to secure to the surface 104 in a fashion that allows the connector 106 to be reversibly detached in a convenient fashion. A reversible connection permits the connector 106 to be connected to the surface 104 to a degree sufficient to retain the positioner 12 in use at the desired position on the surface 104 until the user desires to remove or reposition the positioner 12, at which the user may detach and reattach the connector 106 at a different location with the same or a substantially similar level of affixation as before. In some cases, a suitable reversibly reusable adhesive may be detached and reattached without a noticeable loss of adhesive strength.

Referring to FIGS. 6A and 6B, each storage surface connector 106 may comprise a reversibly reusable adhesive that may contain a polyurethane gel. Polyurethane gel adhesives are a type of adhesive that features a gel-like consistency, derived from the polymerization of polyurethane compounds. These adhesives may exhibit unique properties, combining the flexibility of polyurethane chemistry with the viscoelastic nature of a gel. Polyurethane gel adhesives may comprise excellent bond strength, high elongation, and resistance to impact and vibration. Polyurethane gel adhesives often provide good thermal and chemical resistance, enhancing their suitability for challenging environments. The gel consistency allows for easy application, even on vertical surfaces, and provides gap-filling capabilities. Polyurethane gel adhesives are particularly valued for their durability and ability to withstand harsh conditions, such as wide temperature ranges, making them a reliable choice in industries where robust bonding is crucial for long-term performance. The adhesive layer 108 that attaches to the surface 104 may be made from a removable and repositionable pressure-sensitive adhesive such as a polyurethane gel. Polyurethane gels may provide a relatively much stronger grip than magnetic organizers, without leaving residue on the surface after removal unlike other non-removable adhesives and may be reused multiple times and even washed while still maintaining adhesive properties, also unlike non-repositionable adhesives. The use of polyurethane gel may make it easy for the user to reorganize their drawer from time to time as desired.

Referring to FIGS. 6A and 6B, the storage surface connector 106 may comprise a peel-and-stick adhesive with an adhesive layer 108 and a removable cover layer 110. Peel-and-stick adhesives may be designed for easy application and bonding without the need for additional tools or equipment. Peel-and-stick adhesives typically comprise an adhesive layer 108 that is protected by a backing material such as a removable cover layer 110. The removable cover layer 110 may in use be removed by the user prior to use, exposing the adhesive layer 108, allowing the layer 108 to thereafter be pressed into direct contact with the substrate. A removable cover layer 110 may have a suitable composition to prevent bonding with the adhesive layer 108, such as if the layer 110 is coated with wax. Peel-and-stick adhesives may offer versatility in bonding to various surfaces, including plastics, metals, and paper.

Referring to FIGS. 1, 6A-6B, 8A-8D, and 9A-9D, at least one tool receptacle 20 or 37 may be defined between cooperating walls 28 of the top parts 18 or 36 of the respective receptacle. Each set of walls 28 may define cooperating inner guide wall surfaces 27 or 43, which may comprise a pair of opposed wall surfaces that define a hand-tool-end channel 24 or 40. Referring to FIGS. 6A-6B, in the example shown, the cooperating guide walls 28 of second end holder 32 may define a pair of opposed inner wall surfaces 27 as shown, that are spaced from one another and define a hand-tool-end-receiving channel 40 with one or more tool-receiving open lateral ends 41. The inner wall surfaces 27 may be opposed to one another in the sense that they are separated by a gap sufficient to receive a tool end, with or without directly contacting one another. As shown in FIG. 6B, the cooperating wall surfaces 27 may be connected adjacent to one another. For example, the wall surfaces 27 may be connected by a bridge wall 44 that defines a tool-enclosing closed lateral end 42 of the tool receptacle. A bridge wall 44 may run transverse the walls 28 and may link the walls 28, forming one or more corners that laterally block the channel 40 to prevent a tool end from extending past the end of the holder while in use. It should be understood that, in this document, any reference to a feature of one of the holders 14 or 32 may be support for the same feature on the other of the holders 14 or 32 as the case may be. In some cases, the wall surfaces 27 may be connected but oriented at acute or oblique angles relative to one another, such as arranged in a V shape with no flat bottom, or in curved fashion, depending on the shape of the tool that is intended to be received.

Referring to FIGS. 6A-B, 8A-D and 9A-D, the cooperating inner wall surfaces 27 may be shaped to receive and support a tool end or other part of a tool. In the example shown, the inner wall surfaces 27, such as inner guide wall surfaces 43, may be tapered, for example to have decreasing distance from one another with decreasing distance from the base part 34. The tapering of the inner guide wall surfaces 43 may assist the cooperating inner wall surfaces in being shaped to hold the hand-tool-end by gravity, friction, or interference fit. As shown, the inner wall surfaces 27 (for example surfaces 43) may be tapered with decreasing distance from one another with increasing lateral distance from an open lateral end 26 or 41 of the tool end channel 24 or 40 of the tool receptacle 20 or 37 of holder 14 or 32. The tapering may have decreasing distance to bridge wall 35. In the example shown, the use of dual tapering (vertical and horizontal planes as shown), may act to shape the tool receptacle 20 or 40 to receive a part of the tool, such as a pointed tip 72 of pliers 68 or a handle 66 of a screwdriver 60. The holder 14 or 32 may define a rim that extends continuously along and between the walls.

Referring to FIGS. 10A-D, in the case of a tool shaft holder 32A, the receptacle 37 may have opposed open lateral ends 41 for channel 40. Tapered inner wall surfaces 27 may slope toward one another with decreasing distance from base part 34, forming a channel for the tool shaft during use. In some cases, a tool shaft holder 32A may be used at an intermediate location between the tool end holders 14 and 32 to retain and support a tool 50 in use.

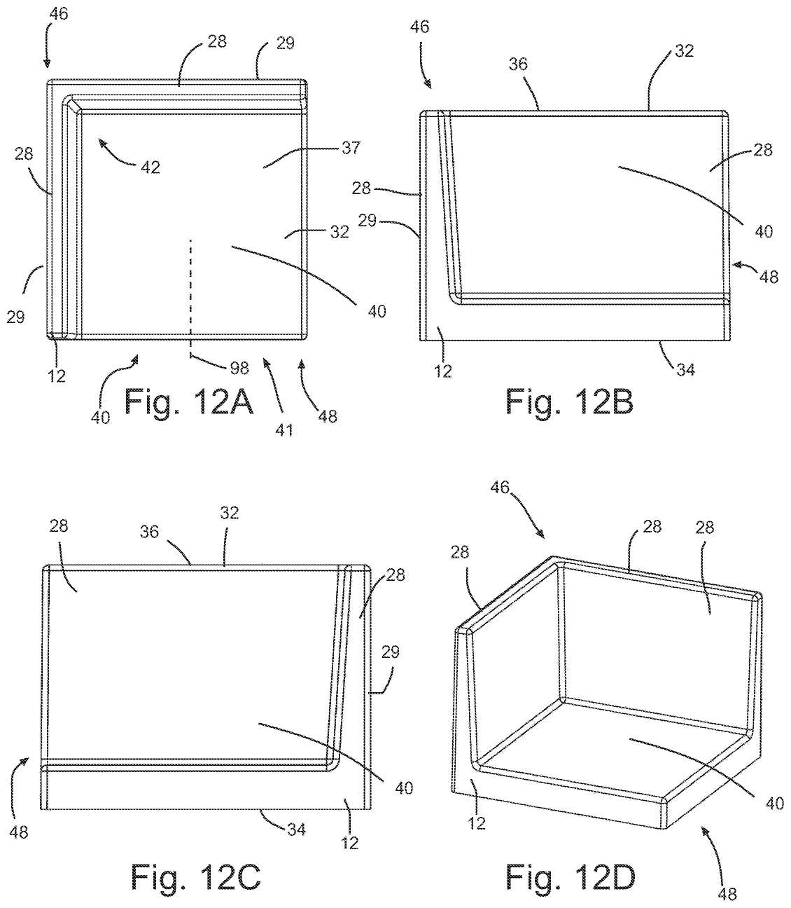

Referring to FIGS. 1, 4, and 12A-D, in some cases the cooperating upright guide walls 28 may be connected adjacent to one another. In the example shown, the inner guide wall surfaces 27 may be oriented transverse one another to define a closed lateral corner 46 opposite to an open lateral corner 48. Open corner 48 may itself define an end of a lateral tool end receiving channel 40. The use of corner holders 32 as shown may be useful for handle ends 76 of a jawed tool, such as a set of pliers, whose handles 74 may pivot relative to one another. In some cases, a pair of holders 32 may be used to receive and restrain the opposed handle ends 76 of the pliers. In some cases, the holders 32 may restrain the handle ends 76 under compression, for example if the pliers incorporate a torsion spring. The inner guide wall surfaces 27 may be formed of panels with vertical or near-vertical inner wall surfaces to retain compressed handle ends 76 from popping out vertically from the tool receptacle 37.

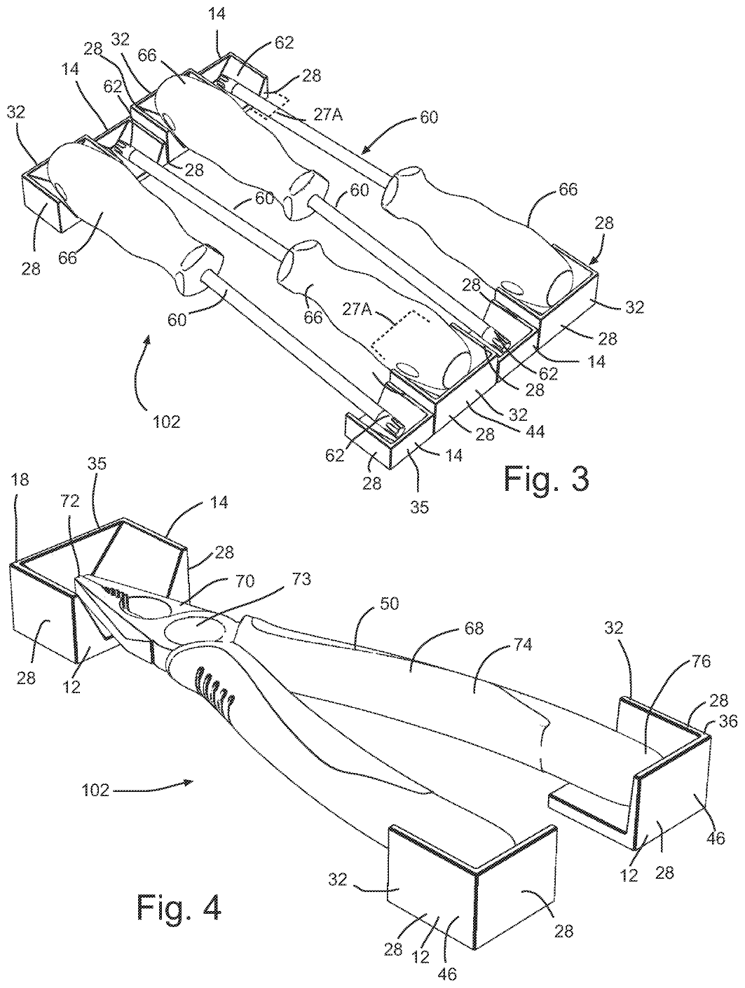

Referring to FIGS. 1, 3, 8A and 9A, the holders of each set of holders for a unique tool 50 may be sized differently, to correspond with the respective sizes of the parts of the tool 50 that are restrained or supported. In the example shown, differently sized receptacles 20 and 37 are used to hold the relatively small working tip 62 and relatively large handle end 66 of various screwdrivers of different sizes. Thus, in the example shown in FIG. 3, the cooperating inner guide wall surfaces 27 of the first hand-tool-end holder 14 are separated to define an average separation distance 27A that is smaller than the average separation distance 27A defined by the inner guide wall surfaces 27 of the second hand-tool-end holder.

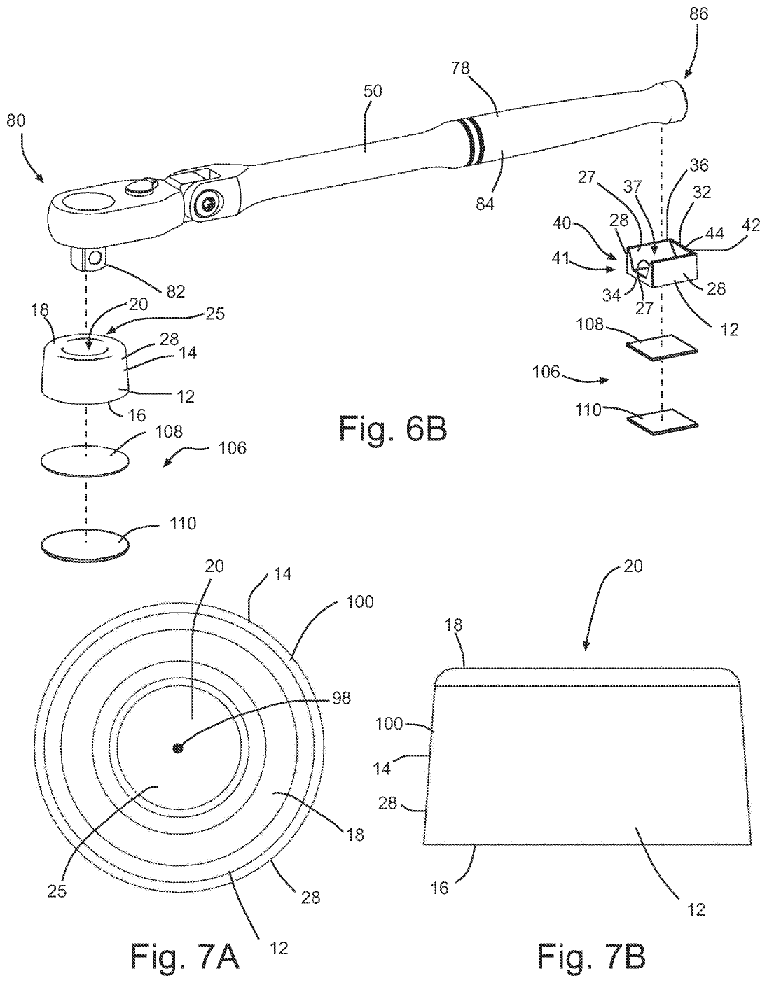

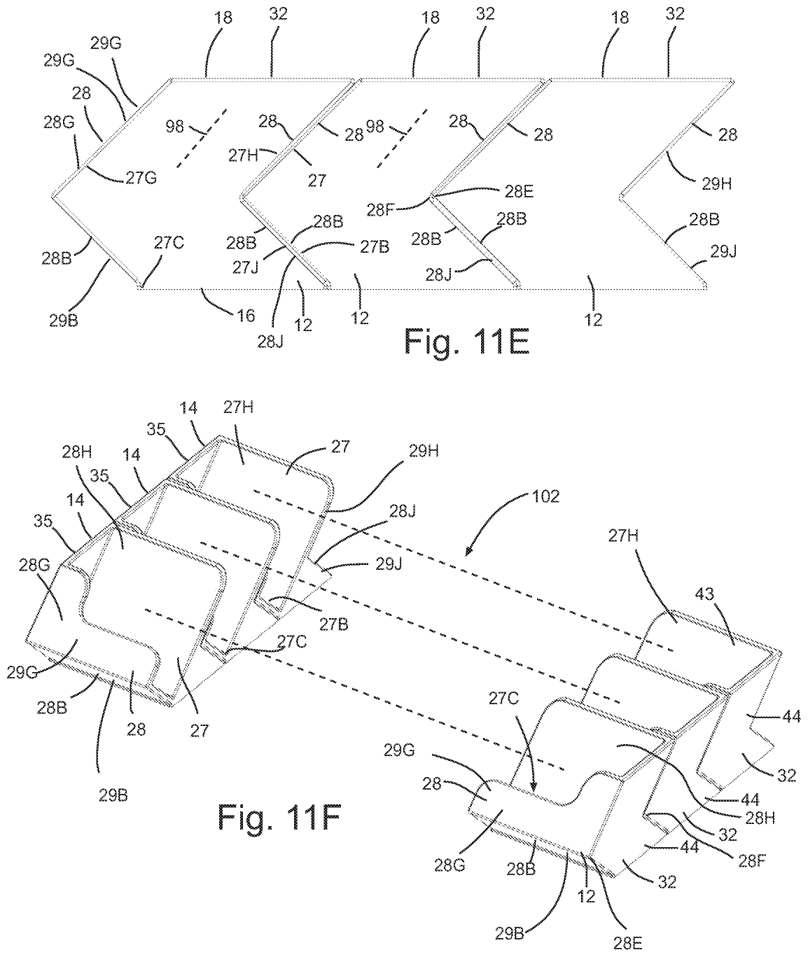

Referring to FIGS. 1, 5, and 11A-F, the inner guide wall surfaces 27 may be shaped in various ways. In the example shown, the inner guide wall surfaces 27 may be angled to define an oblique hand-tool-end entry axis 98 (FIG. 11E). The first hand-tool-end holder and the second hand-tool-end holder may be structured to nest laterally with adjacent first hand-tool-end holders and second hand-tool-end holders. In the example shown, each holder 14 and 32 are shaped to nest laterally inset with adjacent holders, forming a chevron lateral profile. The inner guide wall surfaces 27 may incorporate inner guide wall surfaces 27 angled obliquely relative to a normal of the surface 104 upon which the holders rest or mount to. The inner wall surfaces 27 may be aligned similar to a paper file holder stand where multiple files may be retained in different angled slots of a file organizer, for example, formed by an upper wall inner surface 27G (defined on an upper wall 28G), a lower wall inner surface 27B (defined on a lower wall 28B) and a rear wall inner surface 27H (defined on a rear wall 28H). The rear wall surfaces may include a lower inner surface 27J (defined on a rear lower wall 28J). A base 27C of each tool receptacle 20 and 37, respectively, may also be angled oblique to the normal of the surface 104 in use. Referring to FIGS. 11E-F, each combination of upper wall 28G and lower wall 28B may form a respective lateral point 28E, which may nest within and mate with a respective lateral indent 28F formed between the rear wall 28H and lower rear wall 28J allowing adjacent holders to nest relative to one another. The lower rear walls 28J and upper rear walls 28H may nest adjacent the lower walls 28B and upper walls 28G, respectively. In the example shown, during nesting, outer wall surfaces 29 contact one another between adjacent tool holders. For example, lower wall outer surfaces 29B and upper wall outer surfaces 29G contact rear wall outer surfaces 29J and rear wall outer lower surfaces 29H, respectively. Referring to FIGS. 1 and 5 as shown, various tools, such as relatively flat tools such as wrenches, may be accommodated with nesting holders to fit a relatively large number of tools in a small compact area. Thus, outer wall surfaces 29 sides of the first hand-tool-end holder and the second hand-tool-end holder may be structured to nest laterally with outer wall surfaces 29 of adjacent first hand-tool-end holders and second hand-tool-end holders.

Referring to FIGS. 1, the tool holders may be shaped to receive and support a ratchet tool. A square drive tang 82 of the drive end 80 of the ratchet 78 may be received in the first hand-tool-end holder 14; for example, a drive square, key, or tang 82 of the ratchet 78 may be received in the drive tang receiving socket 25 of a ratchet drive tang receiver 100 of the ratchet 78. An end 86 of the handle 84 of the ratchet 78 may be received in the second hand-tool-end holder 32. The socket 25 may be shaped to receive a drive tang or other keyed surface of the tool, in this case a square socket drive end, but in other cases, having other shapes. The drive tang receiver 100 may incorporate side walls to receive and latch, or simply support by gravity, the drive tang or other male part of a ratchet 78.

Referring to FIG. 1, the system 10 may be provided in a kit, for example with plural tool positioners 12. The tool positioners 12 may include one or more of the types discussed (and others), in order to provide a user with the flexibility to accommodate and organize a relatively large amount of same and different tools. A kit of parts may refer to a systematic collection of individual components or elements that are designed to be assembled together to create a functional system or product. This approach is commonly employed in engineering, manufacturing, and product design to streamline production, enhance modularity, and facilitate ease of assembly. Each component within the kit is carefully designed to interconnect with others, often through standardized interfaces or connectors, allowing for efficient and flexible construction. This modularity not only simplifies manufacturing processes but also facilitates customization and maintenance, as individual parts can be easily replaced or upgraded. Kits of parts find applications in various industries, from consumer products to industrial machinery, enabling cost-effective production and versatility in adapting to specific requirements. The technical specifications and design considerations of each part within the kit are crucial to ensuring seamless integration and optimal functionality of the assembled system or product.

The systems disclosed here may incorporate various features. The holders may be different. More or fewer than two holders may be present. The holders may be sized differently to fit different tools or different parts of the same tool. The systems 10 disclosed here may be used with items other than hand tools, for example with powered tools, and tools such as utensils, cutlery, and others. Tapered surfaces may be curved, straight, or combinations of the two. The tool holders disclosed here may be formed by gripping surfaces that grip the tool in use. A grip may refer to an engagement that supports the tool with greater retention than if the tool were simply resting by gravity unfastened to a surface, without having the same engagement as with an adhesive, strap, or fastener. High friction materials, such as rubber or polyurethane, ABS plastic and others, may be used to form the walls that define the tool receptacles in use, to prevent or minimize sliding or unintentional repositioning of tools 50 in a drawer.

Although gravity fitting is illustrated in the embodiments of the figures, in some cases the tool holders may hold respective tools by other fits, such as via an interference fit. An interference fit, also known as a pressed fit or friction fit, is a form of fastening between two tightfitting mating parts that produces a joint which is held together by friction after the parts are pushed together. An interference fit may eliminate the need for additional securing mechanisms such as clamps or fasteners, streamlining the tool holder's design and minimizing complexity. The result is a reliable and efficient tool storage solution that facilitates easy access while maintaining a firm and secure hold on the tools, contributing to a safer and more organized working environment in a variety of industrial, workshop, or other settings.

Table of parts

| | |
|---|---|
| 10 | tool organization system |
| 12 | tool positioner |
| 14 | first end holder |
| 16 | base part |
| 18 | top part |
| 20 | tool receptacle |
| 24 | tool end channel |
| 25 | drive tang receiving socket |
| 26 | tool receiving open lateral end |
| 27 | inner guide wall surfaces |
| 27A | separation distance |
| 27B | lower wall inner surfaces |
| 27C | base of channels |
| 27G | upper wall inner surfaces |
| 27H | rear wall inner surfaces |
| 27J | rear wall inner lower surfaces |
| 28 | guide walls |
| 28B | lower walls |
| 28E | point |
| 28F | indent |
| 28G | upper walls |
| 28H | rear wall |
| 28J | rear wall lower |
| 29 | outer wall surfaces |
| 29B | lower wall outer surfaces |
| 29G | upper wall outer surfaces |
| 29H | rear wall outer surfaces |
| 29J | rear wall outer lower surface |
| 31 | tool-enclosing closed lateral end |
| 32 | second end holder |
| 32A | tool shaft holder |
| 34 | base part |
| 35 | bridge walls |
| 36 | top part |
| 37 | tool receptacle |
| 40 | tool end channel |
| 41 | tool receiving open lateral end |
| 42 | tool-enclosing closed lateral end |
| 43 | inner guide wall surfaces |
| 44 | bridge walls |
| 46 | closed lateral corner |
| 48 | open lateral corner |
| 49 | separation distance |
| 50 | unique tool |
| 52 | wrench |
| 53 | shaft |
| 54 | open end |
| 58 | box end |
| 60 | screwdriver |
| 62 | tip |
| 66 | handle |
| 68 | pliers |
| 70 | Jaws |
| 72 | jaw tip |
| 73 | fulcrum |
| 74 | handles |
| 76 | handle ends |
| 78 | ratcheting socket wrench (ratchet) |
| 80 | drive end |
| 82 | square drive tang |
| 84 | handle |
| 86 | handle end |
| 88 | socket adapters |
| 90 | socket extension ratchet end |
| 92 | socket extension socket end |
| 94 | first end separation distance |
| 96 | second end separation distance |
| 98 | tool end entry axis |
| 100 | ratchet drive tang receiver |
| 102 | tool receiving zone |
| 104 | tool storage surface |
| 106 | tool storage surface connector |
| 108 | adhesive layer |
| 110 | backing cover layer |
| 112 | drawer |

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A tool organization system comprising:
a tool positioner formed of a first tool-end holder and a second tool-end holder that are structured to be spaced from one another a tool-span apart and oriented toward one another in use to cooperate to support a hand tool in a predetermined position on a hand tool storage surface; and
each of the first tool-end holder and the second tool-end holder having:
a base part with a storage surface connector; and
a top part defining a tool receptacle.

2. The tool organization system of claim 1 in which each storage surface connector comprises a pressure sensitive adhesive.

3. The tool organization system of claim 1 in which each storage surface connector comprises a reversibly reusable adhesive.

4. The tool organization system of claim 3 in which the reversibly reusable adhesive comprises a polyurethane gel adhesive.

5. The tool organization system of claim 2 in which the storage surface connector comprises a peel-and-stick adhesive with an adhesive layer and a removable cover layer.

6. The tool organization system of claim 1 in which at least one of the tool receptacles are defined between cooperating inner guide wall surfaces of the top part.

7. The tool organization system of claim 6 in which the cooperating inner guide wall surfaces comprise a pair of opposed wall surfaces that are spaced from one another and define a tool-end-receiving channel with one or more tool-receiving open lateral ends.

8. The tool organization system of claim 7 in which the pair of opposed wall surfaces are connected by a bridge wall that defines a tool-enclosing closed lateral end of the tool receptacle.

9. The tool organization system of claim 6 in which the cooperating inner guide wall surfaces are connected adjacent to one another.

10. The tool organization system of claim 9 in which the cooperating inner guide wall surfaces are oriented to define a closed lateral corner opposite to an open lateral tool-end-receiving corner.

11. The tool organization system of claim 6 in which the cooperating inner guide wall surfaces are tapered to have decreasing distance from one another with decreasing distance from the base part.

12. The tool organization system of claim 6 in which:
both tool receptacles are defined by cooperating inner guide wall surfaces; and
the cooperating inner guide wall surfaces of the first tool-end holder are separated to define an average separation distance that is smaller than an average separation distance defined between cooperating inner guide wall surfaces of the second tool-end holder.

13. The tool organization system of claim 6 in which the cooperating inner guide wall surfaces are shaped to hold the tool-end by one or more of gravity, friction, and interference fit.

14. The tool organization system of claim 6 in which the cooperating inner guide wall surfaces are angled to define an oblique tool-end entry axis of the tool receptacle.

15. The tool organization system of claim 1 in which the first tool-end holder comprises a ratchet drive tang receiver.

16. The tool organization system of claim 1 in which outer lateral sides of the first tool-end holder and the second tool-end holder are structured to nest laterally with outer lateral sides of adjacent first tool-end holders and second tool-end holders.

17. The tool organization system of claim 1 further comprising a plurality of tool positioners.

18. A kit comprising the plurality of tool positioners of claim 17.

19. The tool organization system of claim 17 in which the plurality of tool positioners are distributed about a hand tool storage surface, with the first tool-end holder and second tool-end holder of each tool positioner separated from one another and facing one another to define a tool-receiving zone therebetween.

20. The tool organization system of claim 19 in which the plurality of tool positioners each support a respective unique tool between the first tool-end holder and the second tool-end holder of the respective tool positioner.

21. The tool organization system of claim 20 in which the unique tools comprise hand tools.

22. The tool organization system of claim 21 in which the unique tools comprise one or more of:
a ratcheting socket wrench (ratchet);
a socket adapter;
a screwdriver;
a set of pliers; or
a wrench.

23. The tool organization system of claim 19 in which the hand tool storage surface is a base of a drawer in a tool box or tool cabinet.

24. A method comprising:
connecting the first tool-end holder and the second tool-end holder of the tool organization system of claim 1 in spaced relationship on a storage surface; and
mounting a hand tool to or on the tool positioner, with a first tool-end of the hand tool received in the first tool-end holder and a second tool-end of the hand tool received in the second tool-end holder.
